(19) United States
(12) Patent Application Publication
(10) Pub. No.: US 2020/0146916 A1
(43) Pub. Date: May 14, 2020

(54) MASSAGE TABLE GRIP

(71) Applicant: Lisa D. Booth, Blanding, UT (US)

(72) Inventor: Lisa D. Booth, Blanding, UT (US)

(21) Appl. No.: 16/663,325

(22) Filed: Oct. 24, 2019

Related U.S. Application Data
(60) Provisional application No. 62/757,654, filed on Nov. 8, 2018.

(51) Int. Cl. A61G 13/10; F16M 13/02; F16B 2/10; F16B 2/00

(52) U.S. Cl. CPC A61G 13/101; F16B 2/005; F16B 2/10; F16M 13/022

(57) ABSTRACT

A device; the device includes a clamp, a receptacle and a pocket. The device secures to a massage table to hold oils and lotions, effectively ensuring that a therapist's lotions and oils are always in the same spot to prevent losing or misplacing them. The device eliminates the need for therapists to wear the oil and lotion bottles around their waist.

### CROSS REFERENCE TO RELATED APPLICATION

The present application is related to and claims priority to U.S. Provisional Patent application Ser. No. 62/757,654 filed Nov. 8, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of massage therapy and more specifically relates to a massage therapy tool holder for a massage table.

### 2. DESCRIPTION OF RELATED ART

Without a convenient and accessible location to place lotions, oils, and other items, massage therapists often feel disorganized. Some therapists will wear a belt around their waist to hold items, but these belts can be heavy and taxing on the lower back. The bulky belt can also impede their ability to work on their client. A suitable solution is desired.

U.S. Pub. No. 2007/0068515 to Natalie Churchill relates to an apparatus for administration of aromatherapy on a massage table or chair. The described apparatus for administration of aromatherapy on a massage table or chair includes devices for providing aromatherapy to a person undergoing massage therapy. More specifically it relates to aroma devices for providing aromatherapy while undergoing massage therapy and methods of making and using the aromatherapy device of the present invention. A preferred embodiment comprises an aroma container, a clamp, and a connector joining the aroma container to the clamp. The connector may be formed from a flexible material allowing movement of the aroma container relative to the clamp. The aroma container and clamp may be coupled to the connector by a ball and socket joint, a snap-fit joint, welding, adhesive, screws, bolts or threading.

### BRIEF SUMMARY OF THE INVENTION

In view of the foregoing disadvantages inherent in the known massage therapy art, the present disclosure provides a novel massage table grip. The general purpose of the present disclosure, which will be described subsequently in greater detail, is to provide a device that secures to a massage table to hold oils and lotions. The device may ensure that a therapist's lotions and oils are always in the same spot to prevent losing or misplacing them and offers a convenient location for the items to ensure that they are accessible when needed. The device may eliminate the need for therapists to wear the oil and lotion bottles around their waist, allowing for a smooth and organized experience for both the therapist and the client.

A device is disclosed herein. The device includes a clamp which may include a first clamp-half and second clamp-half opposite the first clamp-half The first clamp-half may include a first grip-end, a first receptacle-end and a first-length therebetween. Similarly, the second clamp-half may include a second grip-end, a second receptacle-end and a second-length therebetween. The first clamp-half and the second clamp-half may be hingedly-connected at a mid-section of the first-length and the second-length. The clamp may be configured to attach the device to the at least one table leg via the first grip-end and the second grip-end.

Further, a receptacle may be attached to the clamp via the first receptacle-end and the second receptacle-end and may include a receptacle-capacity defined by a receptacle-body. A pocket may be attached to an outer-surface of the receptacle-body, the pocket may include a pocket-capacity.

A method of using device is also disclosed herein. The method of using device may comprise the steps of: providing the device as above; attaching the device to the at least one table leg via the clamp; placing at least one item into at least one of the receptacle-capacity and the pocket-capacity; performing a massage on the table; selectively removing and replacing the at least one item from the receptacle-capacity and the pocket-capacity through the massage.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a massage table grip, constructed and operative according to the teachings of the present disclosure.

FIG. 1 is a side front perspective view of the device during an ‘in-use’ condition, according to an embodiment of the disclosure.

FIG. 2 is a side front perspective view of the device of FIG. 1, according to an embodiment of the present disclosure.

FIG. 3A is a side front perspective view of the device of FIG. 1, according to an embodiment of the present disclosure.

FIG. 3B is a side front perspective view of the device of FIG. 1, according to an embodiment of the present disclosure.

FIG. 4 is a front perspective view of the device of FIG. 1, according to an embodiment of the present disclosure.

FIG. 5 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to massage therapy and more particularly to a massage table grip as used to improve efficiency of massage therapy while using a massage table.

Generally disclosed is a device that secures to a table leg to provide therapists with a convenient and accessible location to place lotions, oils, and other necessary items. The device may include a cloth material with a plastic support piece located within the cloth material. The cloth material may include two openings for connecting to the ends of the clamp. The device may clamp and/or clip on to a leg of a massage table. The plastic support piece may be removable for replacement or cleaning. Further, the device may include a pocket for holding items. In addition, the device may further include a bungee rope for a tighter grip. The exact specifications may vary.

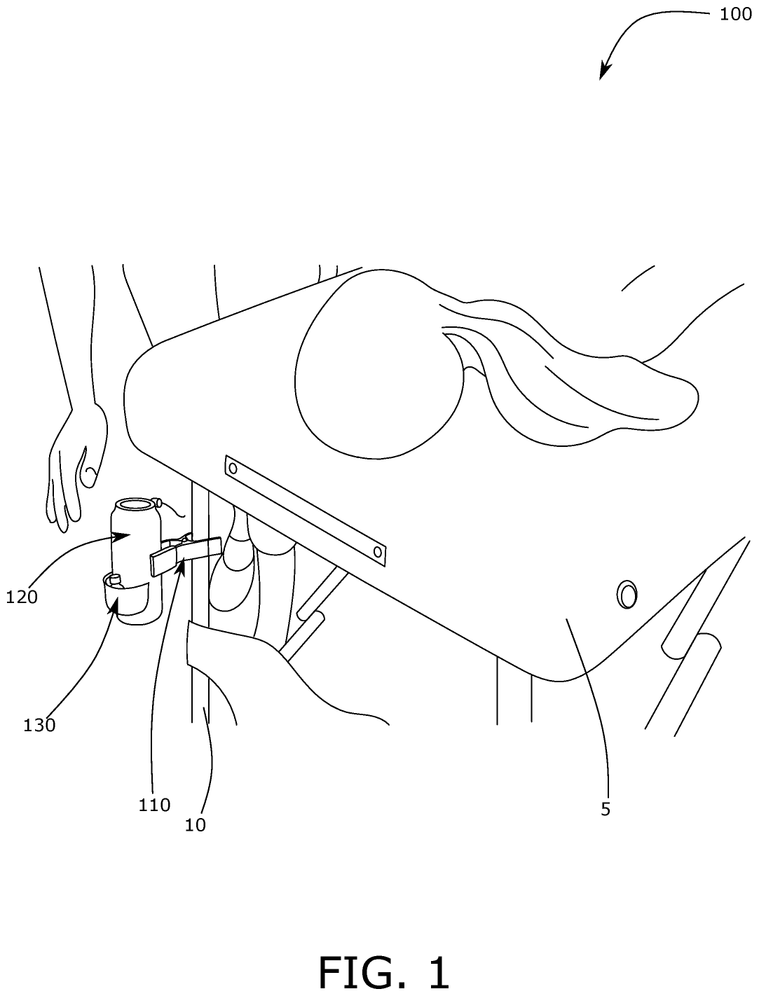

Referring now more specifically to the drawings by numerals of reference, there is shown in FIGS. 1-4, various views of a device 100.

FIG. 1 shows a device 100 during an ‘in-use’ condition 150, according to an embodiment of the present disclosure. As Illustrated, the device 100 may include a clamp 110, a receptacle 120 and a pocket 130. The device 100 may be used for attachment to a table 5, the table 5 including at least one table leg 10.

According to one embodiment, the device 100 may be arranged as a kit. The kit may include a set of user instructions. The instructions may detail functional relationships in relation to the structure of the device 100 (such that the device 100 can be used, maintained, or the like, in a preferred manner).

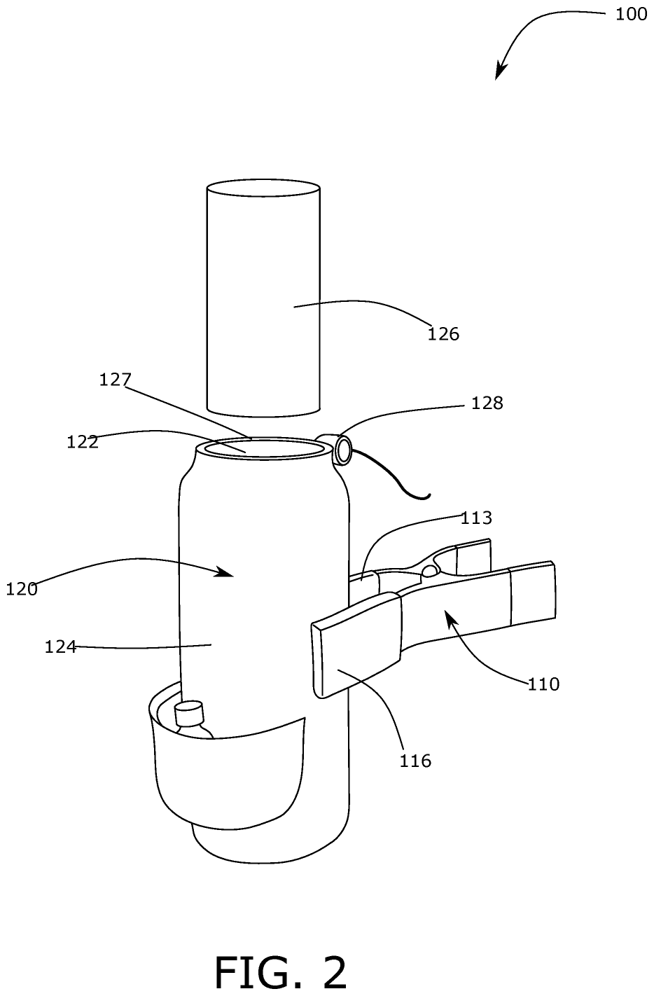

FIG. 2 shows a front side perspective view of the device 100 of FIG. 1, according to an embodiment of the present disclosure. As shown, the receptacle 120 may be attached to the clamp 110 via a first receptacle-end 113 and a second receptacle-end 116. The receptacle 120 may include a receptacle-capacity 122 defined by a receptacle-body 124. Preferably, the receptacle-body 124 may comprise a fabric material. In one embodiment, the fabric material may be cloth material. The fabric material may be particularly useful for absorbing spilled lotions, oils, etc. and configured to be washed and reused.

Further, the receptacle 120 may comprise a support piece 126 attached to the receptacle-body 124 and configured to provide support to the receptacle-body 124. In one embodiment, the support piece 126 may be removable from the receptacle 120. The support piece 126 may comprise a plastic material to provide rigidity to the receptacle. As shown, the receptacle may include a substantially cylindrical shape. The support piece 126 may provide the stability to keep the receptacle 120 in the substantially cylindrical shape. This shape may be particularly useful for accepting cylindrical/tubular shaped bottles such as lotions.

As above, the receptacle 120 may include the receptacle-capacity 122 defined by the receptacle-body 124. In one embodiment, the receptacle-capacity 122 may include a receptacle-volume of between 50-80 cubic inches. However, the receptacle-capacity 122 is not limited to a size. The receptacle-capacity 122 may be contemplated to be sized to fit at least one bottle of lotion ranging from 50 ml-500 ml.

The receptacle-capacity 122 may be accessible via a first open-top 127. Further, a fastener 128 may be located about a periphery of the first open-top 127 to selectively open and close the first open-top 127. Also, in other embodiments the fastener 128 may further aid in attaching the device 100 to the table 5 (FIG. 1). In one embodiment, the fastener 128 may be a drawstring. Further, the fastener 128 may be an elastic cord.

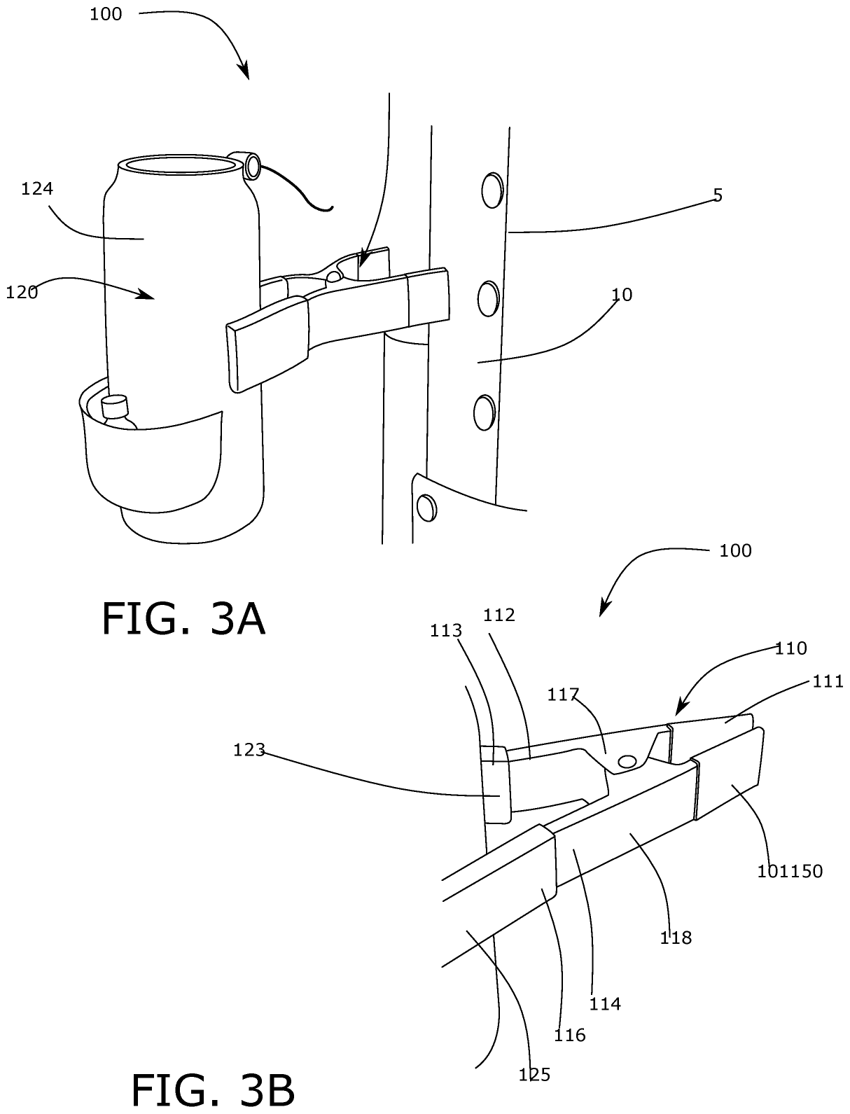

FIGS. 3A-3B show side front perspective views of the device 100 of FIG. 1, according to an embodiment of the present disclosure. The clamp 110 may include a first clamp-half 112 and second clamp-half 114 opposite the first clamp-half 112. The first clamp-half 112 may include a first grip-end 111, the first receptacle-end 113 and a first-length 117 therebetween. Similarly, the second clamp-half 114 may include a second grip-end 115, the second receptacle-end 116 and a second-length 118 therebetween.

In one embodiment, the receptacle-body 124 may further include a first side-sleeve 123 and a second side-sleeve 125, and wherein the first side-sleeve 123 covers the first receptacle-end 113 of the first clamp-half 112, and wherein the second side-sleeve 125 covers the second receptacle-end 116 of the second clamp-half 114.

The first clamp-half 112 and the second clamp-half 114 may be hingedly-connected at a mid-section of the first-length 117 and the second-length 118 and configured to attach the device 100 to the at least one table leg 10 via the first grip-end 111 and the second grip-end 115. In one embodiment, the first clamp-end and the second clamp-end may each include anon-slip material. The non-slip material may further secure the clamp 110 to the table 5 and prevent the clamp 110 from falling. This may be particularly useful for if lotions and oils are spilled near the clamp 110.

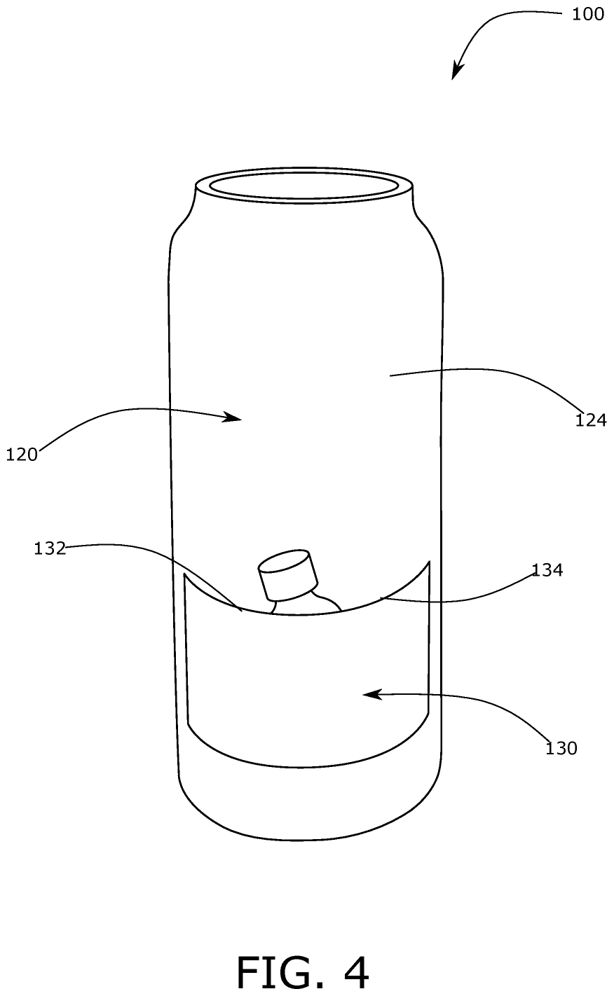

FIG. 4 shows a front perspective view of the device 100 of FIG. 1, according to an embodiment of the present disclosure. As shown, the pocket 130 may be attached to an outer-surface of the receptacle-body 124. The pocket 130 may be attached via sewing, adhesive, hook and loop fastener, buttons, etc. Preferably, the pocket 130 may comprise the fabric material. In some embodiments, the fabric material may be contemplated to same or similar to the fabric material of the receptacle-body 124.

The pocket 130 may include a pocket-capacity 132. The pocket-capacity 132 may be accessible via a second open-top 134. In one embodiment, the pocket-capacity 132 may include a pocket-volume of between 5-15 cubic inches. However, the pocket-capacity 132 is not limited to a size. The pocket-capacity 132 may be contemplated to be sized to fit at least one bottle or vial of oil ranging from 5-50 ml.

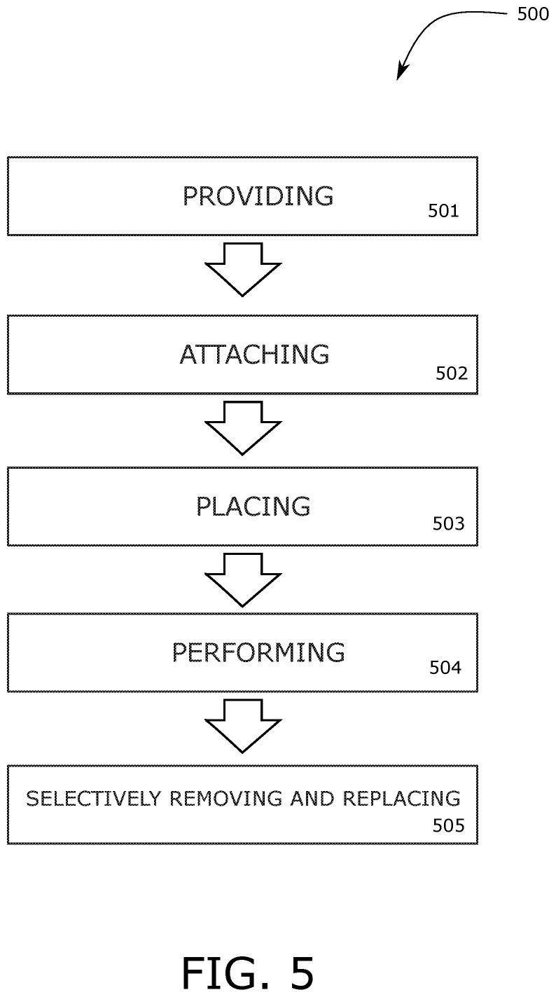

FIG. 5 is a flow diagram illustrating a method of using a device for attachment to a table 500, according to an embodiment of the present disclosure. As illustrated, the method of using a device for attachment to a table 500 may include the steps of: providing 501 the device as above; attaching 502 the device to the at least one table leg via the clamp; placing 503 at least one item into at least one of the receptacle-capacity and the pocket-capacity; performing 504 a massage on the table; and selectively removing and replacing 505 the at least one item from the receptacle-capacity and the pocket-capacity through the massage.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by letters patent is set forth in the appended claims:

1. A device for attachment to a table, the table including at least one table leg, the device comprising:
a clamp including a first clamp-half and second clamp-half opposite the first clamp-half, the first clamp-half including a first grip-end, a first receptacle-end and a first-length therebetween, the second clamp-half including a second grip-end, a second receptacle-end and a second-length therebetween, the first clamp-half and the second clamp-half being hingedly-connected at a mid-section of the first-length and the second-length, the clamp being configured to attach the device to the at least one table leg via the first grip-end and the second grip-end;
a receptacle attached to the clamp via the first receptacle-end and the second receptacle-end, the receptacle including a receptacle-capacity defined by a receptacle-body; and
a pocket attached to an outer-surface of the receptacle-body, the pocket having a pocket-capacity.

2. The device of claim 1, wherein the receptacle-body comprises a fabric material.

3. The device of claim 2, wherein the fabric material is cloth material. Page 11

4. The device of claim 1, wherein the receptacle further comprises a support piece attached to the receptacle-body and configured to provide support to the receptacle-body.

5. The device of claim 4, wherein the support piece is removable from the receptacle.

6. The device of claim 5, wherein the support piece comprises a plastic material.

7. The device of claim 1, wherein the receptacle includes a substantially cylindrical shape.

8. The device of claim 1, wherein the receptacle-capacity includes a receptacle-volume of between 50-80 cubic inches.

9. The device of claim 1, wherein the pocket-capacity includes pocket-volume of between 5-15 cubic inches.

10. The device of claim 1, wherein the receptacle-body further includes a first side-sleeve and a second side-sleeve, and wherein the first side-sleeve covers the first receptacle-end of the first clamp-half, and wherein the second side-sleeve covers the second receptacle-end of the second clamp-half

11. The device of claim 2, wherein the pocket comprises the fabric material.

12. The device of claim 1, wherein the receptacle-capacity is accessible via a first open-top.

13. The device of claim 12, wherein the receptacle further includes a fastener located about a periphery of the first open-top.

14. The device of claim 13, wherein the fastener is a drawstring.

15. The device of claim 13, wherein the fastener is an elastic cord.

16. The device of claim 1, wherein the pocket-capacity is accessible via a second open-top.

17. The device of claim 1, wherein the first clamp-end and the second clamp-end each include a non-slip material.

18. A device for attachment to a table, the table including at least one table leg, the device comprising:
a clamp including a first clamp-half and second clamp-half opposite the first clamp-half, the first clamp-half including a first grip-end, a first receptacle-end and a first-length therebetween, the second clamp-half including a second grip-end, a second receptacle-end and a second-length therebetween, the first clamp-half and the second clamp-half being hingedly-connected at a mid-section of the first-length and the second-length, the clamp being configured to attach the device to the at least one table leg via the first grip-end and the second grip-end;
a receptacle attached to the clamp via the first receptacle-end and the second receptacle-end, the receptacle including a receptacle-capacity defined by a receptacle-body; and
a pocket attached to an outer-surface of the receptacle-body, the pocket including a pocket-capacity; and
wherein the receptacle-body comprises a fabric material;
wherein the receptacle further comprises a support piece attached to the receptacle-body and configured to provide support to the receptacle-body;
wherein the support piece is removable from the receptacle;
wherein the receptacle includes a substantially cylindrical shape;
wherein the receptacle-capacity includes a receptacle-volume of between 50-80 cubic inches;
wherein the pocket-capacity includes pocket-volume of between 5-15 cubic inches;
wherein the receptacle-body further includes a first side-sleeve and a second side-sleeve, and wherein the first side-sleeve covers the first receptacle-end of the first clamp-half, and wherein the second side-sleeve covers the second receptacle-end of the second clamp-half;
wherein the pocket comprises the fabric material;
wherein the receptacle-capacity is accessible via a first open-top;
wherein the pocket-capacity is accessible via a second open-top;
wherein the first clamp-end and the second clamp-end each include a non-slip material;
wherein the receptacle further includes a fastener located about a periphery of the first open-top; and
wherein the fastener is an elastic cord.

19. The device of claim 17, further comprising set of instructions; and
wherein the device is arranged as a kit.

20. A method of using a device for attachment to a table, the table including at least one table leg, the method comprising the steps of:
providing the device including:
a clamp including a first clamp-half and second clamp-half opposite the first clamp-half, the first clamp-half including a first grip-end, a first receptacle-end and a first-length therebetween, the second clamp-half including a second grip-end, a second receptacle-end and a second-length therebetween, the first clamp-half and the second clamp-half being hingedly-connected at a mid-section of the first-length and the second-length, the first grip-end and the second grip-end being configured to grip the at least one table leg;
a receptacle attached to the clamp via the first receptacle-end and the second receptacle-end, the receptacle including a receptacle-capacity defined by a receptacle-body; and
a pocket attached to an outer-surface of the receptacle-body, the pocket including a pocket-capacity;
attaching the device to the at least one table leg via the clamp;
placing at least one item into at least one of the receptacle-capacity and the pocket-capacity;
performing a massage on the table; and
selectively removing and replacing the at least one item from the receptacle-capacity and the pocket-capacity through the massage.
